(19) United States
(12) Patent Application Publication
(10) Pub. No.: US 2024/0017519 A1
(43) Pub. Date: Jan. 18, 2024

(54) REINFORCEMENT MEMBER

(71) Applicants: Nitto, Inc., Teaneck, NJ (US); Nitto Belgium NV, Genk (BE)

(72) Inventors: Priyanka MURTHY, Novi, MI (US); Eli PARLOO, Genk (BE); Peter MUFFELS, Genk (BE)

(73) Assignees: Nitto, Inc., Teaneck, NJ (US); Nitto Belgium NV, Genk (BE)

(21) Appl. No.: 18/038,921

(22) PCT Filed: Nov. 25, 2021
(86) PCT No.: PCT/US21/60883

§ 371 Date: May 25, 2023

Related U.S. Application Data
(60) Provisional application No. 63/118,535, filed on Nov. 25, 2020.

(51) Int. Cl. B32B 3/12; B32B 7/12; B32B 37/26

(52) U.S. Cl. CPC B32B 3/12; B32B 7/12; B32B 37/26; B32B 2307/542; B32B 2037/268

(57) ABSTRACT

Described herein are reinforcing elements that comprise at least one honeycomb element, a first and second adhesive layers and a constraining layer for attachment to a substrate.

### CROSS-REFERENCE TO RELATED APPLICATIONS

This application claims the benefit of U.S. Provisional Application No. 63/118,535, filed on Nov. 25, 2020, which is incorporated by reference herein in its entirety.

### FIELD OF THE INVENTION

The present disclosure generally relates to a reinforcing member for use with industrial products to resist deformation.

### DESCRIPTION OF THE RELATED ART

It has been conventionally known that industrial products can be reinforced. Oftentimes additional materials can provide acoustical or vibrational damping. See United States Patent Publication Nos. US 2013/0043901 and 2009/0277716 and Patent Cooperation Treaty Publication No. WO 2017/214544.

In addition, reinforcing elements have been used in industrial applications as structural reinforcement, e.g., as an applied layer of an epoxy rubber compound (United States Patent Publication No. 2020/0282703, Nitohard® reinforcing elements AS-3000 and/or RE-1000, [Nitto Denko Corporation, Osaka, Japan]). These options can require curing of the elements and/or the structures they are attached to at temperatures of about 160° C. However, with some current changes of automotive body element substrates from sheet metal to a polymeric or plastic material, the high temperatures used to cure such materials, including thermosetting adhesives, can be detrimental to the non-metallic substrates to which the reinforcing material is to be attached. Furthermore, the application of high curing temperatures to the reinforcing element can be difficult to provide, requiring large baking ovens to encompass the body element being reinforced and/or cured.

Thus, there is a need for a reinforcing element capable of reinforcing industrial materials without high temperature cured elements.

### SUMMARY OF THE INVENTION

The present disclosure describes a reinforcing element for application with an industrial product to improve product deformation/deflection resistance. In some embodiments, the optical display comprises at least one holographic optical element. In some embodiments, a reinforcing element for attaching to a substrate is described, wherein the element can comprise a stiffening layer, a first thermoplastic adhesive layer adhering the stiffening layer to a substrate, a high tensile modulus layer and/or a second thermoplastic or thermoset adhesive layer, the high tensile modulus layer adhering to the stiffening layer by the second thermoplastic or thermoset adhesive layer. In some embodiments, the reinforcing layer can be applied to a substrate. In some embodiments, the substrate can comprise a release liner layer. In some embodiments, the substrate can comprise an industrial product, e.g., an industrial sheet material or a plastic fascia. In some embodiments, the stiffening layer can comprise polypropylene. In some embodiments, the stiffening layer can comprise a structured, honeycombed core. In some embodiments, the adhesive layer can comprise a thermoplastic adhesive. In some embodiments, the thermoplastic adhesive can be curable at less than 160° C. In some embodiments, the thermoplastic adhesive can be a thermoplastic pressure sensitive adhesive.

These and other embodiments are described in greater detail below.

### BRIEF DESCRIPTION OF THE DRAWINGS

FIG. 1 is a schematic representation of a reinforcing element described herein.

FIG. 2 is a schematic representation of forces applied to a reinforcing element described herein.

FIG. 3 is a graph of deformation (mm) as a function of applied force (N) testing of an embodiment described herein.

FIG. 4 is a graph of deformation (mm) as a function of applied force (N) testing of an embodiment described herein.

FIG. 5 is a graph of deformation (mm) as a function of applied force (N) testing of an embodiment described herein.

FIG. 6 is a graph of deformation (mm) as a function of applied force (N) testing of an embodiment described herein.

FIG. 7 is a graph of deformation (mm) as a function of applied force (N) testing of an embodiment described herein.

FIG. 8 is a graph of deformation (mm) as a function of applied force (N) testing of an embodiment described herein.

FIG. 9 is a graph of vibration damping effects exhibited by an embodiment described herein, using the Oberst test.

### DETAILED DESCRIPTION

Resisting deformation can refer to the ability to maintain structural integrity without failure. For example, an element which can provide resistance to at least 5 mm deflection despite the application of at least 80 N can mean that the application of 80 Newtons force to a sample will not exhibit greater than 5 mm deflection by the sample material.

This present disclosure relates to a reinforcing element that increases material resistance to mechanical deformation. The disclosure describes an approach that employs thermoplastic materials to provide structural support without using thermosetting resins to adhere to a substrate/element and thus avoid the exposure of the element to high temperature manufacturing processes.

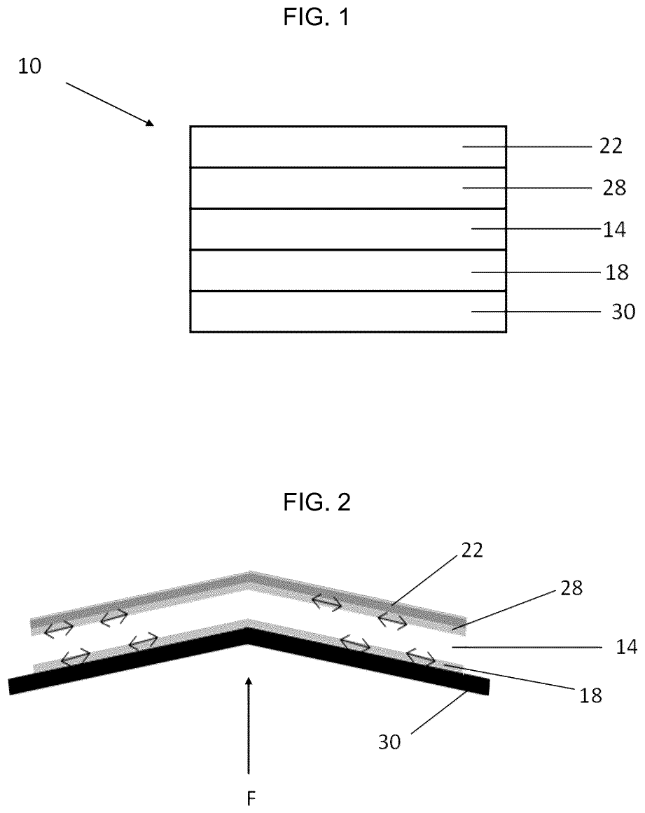

As shown in FIG. 1, in some embodiments, a reinforcing element 10 for attaching to a substrate is provided, wherein the element can comprise a stiffening layer 14 (also referred to herein as a reinforcing layer); a first adhesive layer 18 adhering the stiffening layer to a substrate 30; a high tensile modulus layer 22 (also referred to herein as a constraining layer/element); and/or a second adhesive layer 28, the high tensile modulus layer adhering to the stiffening layer by the second adhesive layer. In some embodiments, the reinforcing layer is applied to the substrate 30. In some embodiments, the substrate can comprise a release liner layer. In some embodiments, the stiffening layer can comprise polypropylene. In some embodiments, the stiffening layer can comprise a structured, honeycombed core. In some embodiments, the adhesive layer can comprise a thermoplastic adhesive. In some embodiments, the thermoplastic adhesive can be curable at less than 160° C. In some embodiments, the thermoplastic adhesive can be a thermoplastic pressure sensitive adhesive. In some embodiments, the reinforcing element can have a shear strength of at least 400 N/4 cm², 500 N/4 cm², and/or 600 N/4 cm², e.g., 610 N/4 cm², 630 N/4 cm², or 800 N/4 cm²

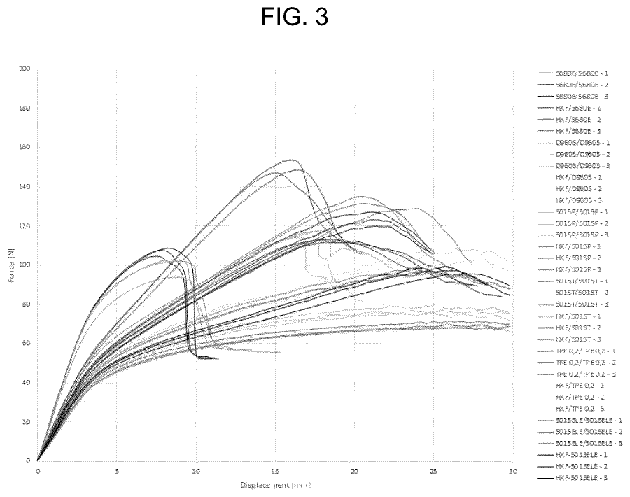

In this regard, as shown in FIG. 2, the reinforcing element can provide resistance to a point or localized area of stress applied, e.g., when a body panel is locally deformed or dented, the stress applied comprising a vector perpendicular to the surface and also exposed to shear stress along a vector orientation parallel to the surface. The shear stress parallel to the surface can comprise a second stress vector parallel to the force vector applied to the surface and a stress vector orthogonal to the stress vector applied to the surface. These considerations can be different than those of sound or vibrational damping, e.g., wherein damping resilience considers resilience to low frequency vibration and/or repeated oscillating movement, usually stress vectors are only perpendicular to the surface plane. In some embodiments, the reinforcing element can bend a distance of less than 2 mm, 5 mm, 7.5 mm, and/or 15 mm deflection upon the application of at least 80, 90, 100, 120, 140, or 160 N. A suitable procedure for determining such deflection that has occurred responsive to the application of the described force at a midpoint between the parallel support points of about 100 mm is a three-point testing apparatus. In some embodiments, the reinforcing element and industrial product can provide at least non-catastrophic failure for any of the aforementioned stresses over any of the aforementioned deflections. Suitable means to determine the resistance to deformation includes the determination of a positive slope of a stress applied or absorbed (Newtons) versus deformation observed (mm) upon the application of a three-point force test similar to that described herein. See FIGS. 3 to 8. Another way to determine the resistance to deformation includes the visual absence of sufficient delamination to constitute fracture failure, observance of material fracture and/or crushing of the honeycomb structure. In some embodiments, the reinforcing element and attached industrial product, e.g., a metal, plastic and/or polymeric sheet, can provide less than or equal to 5 mm deflection despite the application of at least 80 N. In some embodiments, the reinforcing element can provide less than 15 mm of deflection with the application of at least 140 N.

In arriving at the resistance to deformation, the following were also considerations in determination of the structure of the reinforcing element described herein. In a 3-point bend test (used for flexural testing), the displacement “δ_{c}” can be dependent on the geometry of the sample, material properties, and test setup. It can be calculated for a material through the following equation:

δ_{c}=(FL³)/48EI

Where: F=force; L=span in the three-point bend test; E=Young's Modulus (tensile modulus) of the material; and I=moment of inertia. For a sample with a rectangular cross section, the moment of inertia is dependent on the sample dimension as follows:

I_{rectangle}=(bh³)/12

Where: b=sample width; and h=sample thickness. Because of this, we can replace “I” in the first equation, and rearrange to determine the force needed for a given displacement:

F=(4δ_{c}Eb(h³))/L³

Therefore: for a given amount of deflection, and a test setup where both “b” (sample width) and “L” (span) are constant, the force needed to produce the deflection may increase linearly as E (Young's modulus, a property of the composite) increases, and may increase in a cubic manner as h (sample thickness) increases.

In some embodiments, the reinforcing element can comprise a stiffening layer. The stiffening layer can comprise a honeycomb core layer. In some embodiments, the honeycomb structure can comprise individual cells that can be closed on one side of the honeycomb core layer in an alternating fashion, so that on each side open cells and closed cells alternate. In some embodiments, 50% of the cells can be open on one side, while the other 50% of the cells can be closed on that side. On the other side of the respective honeycomb core layer, the cells which are open on the one side may be closed on the other side. In one embodiment, the honeycombed core layer can be as described in Patent Cooperation Treaty Publication No. WO 2008/141688 (European Patent Application Publication No. EP 1995052).

In some embodiments, the honeycomb core layer can comprise polypropylene. In some embodiments, the honeycomb core layer can comprise a thermoplastic polymer. In some embodiments, the thermoplastic polymer material can comprise polyethylene, polypropylene, poly vinyl chloride (PVC), polystyrene, polyimide, polyester, PEEK, PS, and/or PPS. While not wanting to be bound by theory, it is believed that the polymer was selected based on the following considerations: structural integrity, resistance to deformation, low density, mechanical and/or shear forces, e.g., having a shear strength of at least 400 Newtons/4 cm².

Regarding the honeycombed element, while not wanting to be bound by theory, it is believed that by using the honeycomb spacer, the sample thickness can be increased, and thereby increase the amount of force required to produce a given amount of deflection of the material. While not wanting to be bound by theory, it is also believed that this is balanced with the Young's modulus of the composite, which is dependent on both the Young's modulus of each component in the composite, and the volume of the component in the composite. Since it is believed that the honeycomb can have a much lower modulus than the glass cloth, and the thickness of the honeycomb can be much greater than the glass cloth, the honeycomb thickness can be optimized. In some embodiments, the honeycombed element can be between 1.5 and 5.0 mm, e.g., about 3.5 mm thick.

In some embodiments, the constraining element can comprise a high tensile modulus layer or element. In some embodiments, the constraining element can be positioned at spaced intervals to the substrate. In some embodiments, the constraining element can be spaced apart at least 1 mm, 2 mm, 3 mm, 4 mm from the surface of the substrate. In some embodiments, a stiffening layer may be sandwiched between the constraining element and the substrate. While not wanting to be bound by theory it is believed that spacing apart the high tensile modulus layer from the substrate increases the cross-sectional area and increases the bend strength. In some embodiments, the high tensile modulus layer can comprise at least a plurality of fibers. In some embodiments, the high tensile modulus layer can comprise a resin. Examples of the fiber include carbon fiber and glass fiber. These fibers can be used alone or in combination of two or more. In some embodiments, for example, the high tensile modulus layer can comprise a glass fiber; a suitable example of such high tensile modulus layer can be Nittobo WLA209P 60 EP301 brand epoxy resin coated glass fiber sheets (Nitto Boseki Co., Ltd., Tokyo, Japan). In some embodiments, the high tensile modulus layer can have a tensile strength greater than 500 N/25 mm, e.g., 1500±500.

In some embodiments, the reinforcing element can comprise a thermoplastic adhesive. In some embodiments, the thermoplastic adhesive can provide shear strength to the other elements of the reinforcing element. While not wanting to be bound by theory, it is believed that the thickness of the adhesive and Young's modulus of the adhesive can affect the force needed to deflect the material as well. In order to increase the Young's modulus of the adhesives used for the composite while still ensuring that the adhesive forms a bond with a variety of substrates, a PET carrier can be used for all of the adhesives except for the TPE tape. The PET carrier prevents stretching of the adhesive and may increase the Young's modulus. This may increase the performance of the construction (i.e., may increase the amount of force needed to produce a given amount of deflection). In some embodiments, the thermoplastic adhesive can comprise polyethylene (PE), polypropylene (PP), polyvinyl chloride (PVC), polystyrene, polyamide, polyester, polyether ether ketone (PEEK), polyether sulfone (PES), polysulfone, acrylic, rubber, and/or polyphenylene sulfide (PPS). In some embodiments, the thermoplastic adhesive has a shear strength of at least 600 N/4 cm², 610 N/4 cm², and/or 800 N/4 cm.

In some embodiments, the reinforcing element can comprise a thermoplastic adhesive. In some embodiments, the thermoplastic adhesive can be cured at a temperature below 600° C. In some embodiments, the thermoplastic adhesive can be double sided acrylic adhesive, polyester based adhesive tape. In some embodiments, the adhesive tape comprises an acrylate adhesive. In some embodiments, the adhesive tape can comprise a PET carrier. Suitable thermoplastic pressure sensitive adhesives and/or tapes can include, Nitto branded adhesive tapes, e.g., Nitto P-905, Nitto 5605, Nitto 5015ELE, Nitto 5005P, Nitto 5005T, Nitto 5015T, Nitto 5015P, Nitto 5605, Nitto 5610, Nitto 5680E; TPE 0.2 mm DC/T (Nitto Denko Corporation, Osaka, Japan). In some embodiments, the adhesive layers/tape can control the shear deformation of the layers formed from the elements of the reinforcing elements, e.g., the core element, substrate and high tensile modulus layer. In some embodiments, the thermoplastic adhesive can have a shear strength greater than 400 Newtons/4 cm², e.g., 500 N/4 cm², 550 N/4 cm², 600 N/4 cm². In some embodiments, the acrylate adhesive can have a 180° peel strength of at least 10.0 Newtons (N)/millimeter (mm) with a metal substrate (stainless steel). Suitable exemplary adhesives are described in Table 1 below.

TABLE 1

| Adhesive | Type | Substrate | 180° peel strength |
|---|---|---|---|
| Nitto 5610 | Acrylate | Stainless steel plate | 16.9 |
| Nitto 5610 | Acrylate | Aluminum plate | 15.4 |
| Nitto 5610 | Acrylate | Polycarbonate plate | 16.0 |
| Nitto 5605 | Acrylate | Stainless steel plate | 12.2 |
| Nitto 5605 | Acrylate | Aluminum plate | 10.8 |
| Nitto 5605 | Acrylate | Polycarbonate plate | 12.5 |
| Nitto 5680E | Acrylate | Polycarbonate plate | 15.0 |
| Nitto 5680E | Acrylate | glass plate | 16.0 |

In some embodiments, the reinforcing element can further comprise a release liner layer or a release-treated sheet. In some embodiments, a pressure-sensitive adhesive layer can be formed on the release-treated sheet, wherein when the pressure-sensitive adhesive layer is to be exposed, the pressure-sensitive adhesive layer may be protected with the release-treated sheet (a separator) before practical use. The release-treated sheet can be peeled off before actual use. Examples of the material for forming the separator include a plastic film such as a polyethylene, polypropylene, polyethylene terephthalate (PET), or polyester film; a porous material such as paper, cloth and nonwoven fabric; and an appropriate thin material such as a net, a foamed sheet, a metal foil, and a laminate thereof. In one embodiment, the separator can comprise a plastic film, e.g., polyethylene terephthalate (PET).

In some embodiments, the reinforcing element comprising at least the first and second adhesive layers, high tensile modulus layer and honeycomb core element layer can be applied to a substrate. In some embodiments, the substrate can be sheet metal. In some embodiments, the sheet metal can be aluminum, steel, stainless steel, iron, magnesium, copper, zinc, tin, brass, bronze, titanium, tungsten, adamantium, nickel, cobalt, lead, silicon, and/or alloys thereof. In some embodiments, the substrate can be plastic or polymeric substrates used in the automotive or motor vehicle body parts, including body panels, roof panels, bumpers, trim, and/or fenders, e.g., polyolefins (for example polypropylene, polyethylene), polyesters (for example polyethylene terephthalate), polyamides, polyvinyl chloride, sheet molding compound (SMC), plastic fascia comprised of a blend of polypropylene, ethylene-propylene rubber, and 20% talc (Nissan fascia currently used in Nissan Pathfinder model), etc. In some embodiments, the substrate can be fiberglass or glass cloth. In some embodiments, the substrate can be a release liner.

### EXAMPLES

It has been discovered that embodiments of reinforcing composites described herein are useful for improving automobile body parts resistance to deformation and/or impact. These benefits are further shown by the following examples, which are intended to be illustrative of the embodiments of the disclosure but are not intended to limit the scope or underlying principles in any way.

### Example A: Adhesive Tape Shear Strength

A 20 mm×20 mm sample of the tape used was applied between offset acrylic plates. A peeling speed of 50 mm/min was applied to the conjoined plates at 23 and 50% Relative Humidity. The results are described in Table 2 below.

TABLE 2

| Sample | Temperature (° C.) | Shear Strength (N/4 cm²) |
|---|---|---|
| No. 5610/5610BN | 23 | 630 |
| No 5680E | 23 | 800 |
| 5605/5605BN | 23 | 610 |

### Comparative Example 1

As a comparative example a conventional Legetolex D-300 damping material (Nitto Denko, Osaka, Japan) (CE-1) (total thickness 4 mm, 127 micrometer Al-foil constraint layer, density 7 kg/m²) was used.

### Comparative Example 2

As a comparative example (CE-2) an additional damping laminate (Hexadamp, Nitto Belgium NV, Genk, Belgium) was produced using a 127 micrometer Al-foil constraint layer with a honeycomb core layer (50% of cells closed on each side) with a thickness of about 5 mm and a layer of structural damping material between the constraint layer and the honeycomb core layer with a cell fill ratio of 100%. Overall thickness of the CE-2 laminate was 5.1 mm with an overall density of 3.85 kg/m².

### Example 1 (Ex-1)

Three samples were prepared as follows. First and second layers of Nitto brand acrylic adhesive, polyester based double sided adhesive tape (0.5 mm thick Nitto 5680E thermoplastic adhesive material) (Nitto Denko Corporation, Osaka, Japan or Nitto, Inc., Teaneck, New Jersey, USA) had their release liner removed and then were applied to opposite sides of a layer of acrylic 25 mm×150 mm×3.5 mm thick sheet of honeycombed polymeric material (stiffening layer, “HC” in Table 1) (Nitto Belgium NV, Genk, Belgium). A 25 mm×150 mm×2 mm thick sheet of glass cloth (WLA209P 60 EP301 brand epoxy resin coated glass fiber sheets, (Nitto Boseki Co., Ltd., Tokyo, Japan) was registered and placed atop the polymeric adhesive coated layer concurrently with the registration. The stacked embodiment was laminated within a Fortune brand heat press, pressing surfaces at 40° C. with a dwell or press time of about 20 seconds. The overall thickness of the laminate in accordance with the present disclosure was 5.0 mm (without release liner).

Thereafter, a laminate sample prepared as outlined above was cut into pieces of 25 mm width and then the release liner was peeled off therefrom. Then the respective pieces of the reinforcing laminate sheet were pre-contacted with the clean surface of a steel plate 0.8 mm thick by rollers of 2.5 kg.

### Examples 2-17

Examples 2-17 were made in a similar fashion to that of Ex-1, except that different adhesives were used as described in Table 3 below.

TABLE 3

| | | | HC | |
|---|---|---|---|---|
| | Top Layer | Top layer adhesive | (mm) | Bottom adhesive |
| Ex-1 | Nittobo GC | 5680E | 3.5 | 5680E |
| Ex-2 | Nittobo GC | hotmelt | 3.5 | 5680E |
| Ex-3 | Nittobo GC | D9605 | 3.5 | D9605 |
| Ex-4 | Nittobo GC | hotmelt | 3.5 | D9605 |
| Ex-5 | Nittobo GC | 5015P | 3.5 | 5015P |
| Ex-6 | Nittobo GC | hotmelt | 3.5 | D9605 |
| Ex-7 | Nittobo GC | 5015T | 3.5 | 5015T |
| Ex-8 | Nittobo GC | hotmelt | 3.5 | 5015T |
| Ex-9 | Nittobo GC | TPE DC/T 0.2 mm | 3.5 | TPE DC/T 0.2 mm |
| Ex-10 | Nittobo GC | hotmelt | 3.5 | TPE DC/T 0.2 mm |
| Ex-11 | Nittobo GC | 5015ELE | 3.5 | 5015ELE |
| Ex-12 | Nittobo GC | HXF hotmelt | 3.5 | 5015ELE |
| Ex-13 | Nittobo GC | TPE DC/T 0.2 mm | 3.5 | 5680E |
| Ex-14 | Nittobo GC | 5005P | 3.5 | 5005P |
| Ex-15 | Nittobo GC | 5005P | 5.0 | 5005P |
| Ex-16 | Nittobo GC | 5605 | 3.5 | 5605 |
| Ex-17 | Nittobo GC | 5605 | 5.0 | 5605 |

Where use was indicated, the Nittobo GC can be secured from Nitto Boseki Co., Ltd. (Tokyo, Japan), and the adhesives mentioned above can be secured from Nitto Denko Corporation (Osaka, Japan), Nitto Europe NV (Genk, Belgium), and/or Nitto, Inc. (Teaneck, NJ, USA).

Reinforcement Properties

Part 1

The reinforcement properties were evaluated by measuring the flexural strength in relation to the displacement using a 3-point bend test mode upon an Instron testing instrument (Instron, Norwood, MA, USA). Test specimens were constructed using a sandwich configuration, with a steel panel (dimensions 0.8 mm×25 mm×150 mm) with the steel panel up, span between bottom rest positions 100 mm, a testing bar was moved down at about 40 mm per second on a lengthwise center portion of the test piece from above in a vertical direction and was pressed down against the laminated steel plate until the test piece was bent or displaced by the desired vertical displacement, e.g., 5 mm or 15 mm from its original position. The force required to bend the laminated plate was measured as flexural strength (Newtons [N]), which was evaluated as the reinforcing effect. As force is equal to load, FIGS. 3 to 8 may use either term to indicate force.

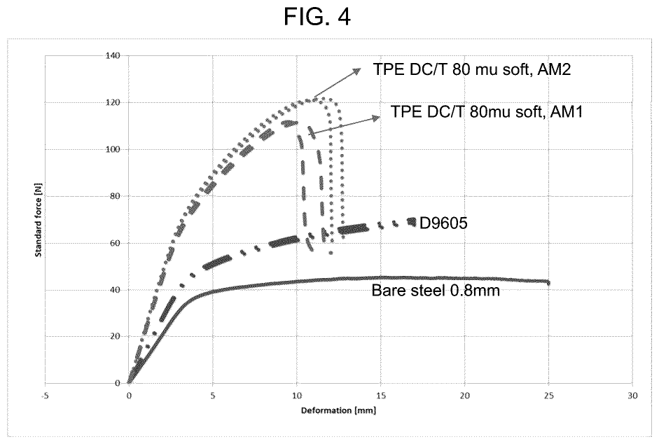

As a comparative example, the flexural strength of a non-laminated steel panel was measured. The measurement results shown in FIG. 3 demonstrate that laminating the steel panel with the material of the present invention results in excellent reinforcement obtained, allowing at least 5 mm and/or 15 mm displacement while maintaining a positive slope, exhibiting a non-fracture or stress failure at 80 N or 140 N respectively. The measurement results shown in FIG. 4 demonstrate that laminating the steel panel with the material of the present invention using a non-preheated TPE adhesive and a preheated TPE adhesive results in excellent reinforcement obtained, allowing at least 10 mm and/or 13 mm displacement while maintaining a positive slope, exhibiting a non-fracture or stress failure at 110 N or 120 N respectively, compared to laminating the steel panel with the material of the present invention using D9605 adhesive. Preheating the TPE adhesive in this case has a positive effect compared to non-preheating.

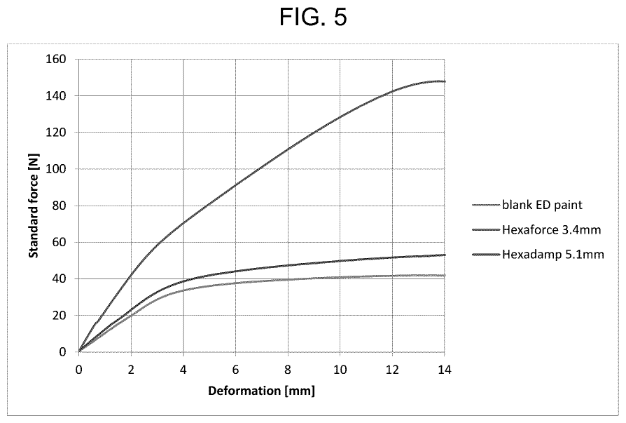

In FIG. 5, the measurement results demonstrate that laminating the steel panel with the material of the present invention as compared with laminating the steel panel with the material of CE-2 (NittoDamp D-300 brand laminate) and/or without additional laminated elements shows excellent comparative reinforcement. A blank was first measured using steel panel coated with ED paint. The material of the present invention (referred to as “Hexaforce 3.4 mm in FIG. 5) showed excellent reinforcing effect, allowing 14 mm displacement/deformation while maintaining a positive slope, exhibiting a non-fracture or stress failure at about 150 N. CE-2 (referred to as “Hexadamp 5.1 mm in FIG. 5), on the other hand, exhibited minimal reinforcing effects that were barely improved over the blank steel panel, and thus it would not be ideal as a reinforcing material.

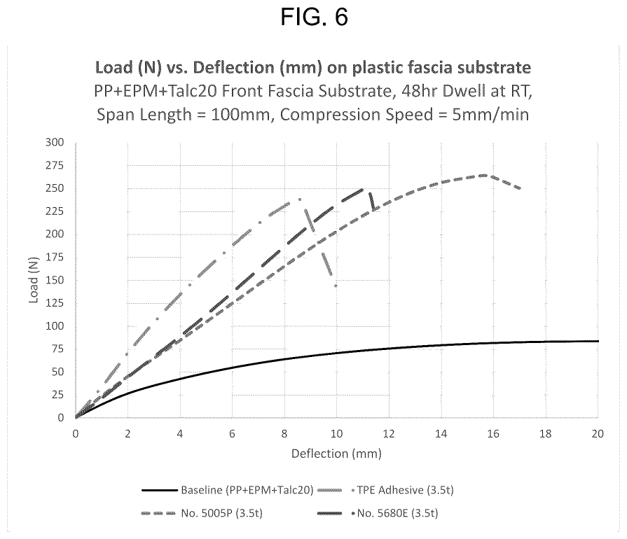

In FIG. 6, the 3-point bend test measurement results demonstrate that laminating a plastic fascia (in this case comprising polypropylene, ethylene-propylene rubber, and 20% talc; Nissan fascia currently used in Nissan Pathfinder model) with the material of the present invention using TPE adhesive, adhesive 5680E, and adhesive 5005P has superior reinforcement results, allowing at least 8 mm, 11 mm, and/or 16 mm displacement while maintaining a positive slope, exhibiting a non-fracture or stress failure at 235 N, 250 N or 260 N respectively, compared with a plain unlaminated plastic fascia. In this test, the adhesives were adhered with one back and forth stroke using a 2.2 kg roller and allowed to dwell at room temperature for 48 hours. The span length was 100 mm and the compression speed was 5 mm/min. The thickness of the stiffening layer was 3.5 mm in each sample.

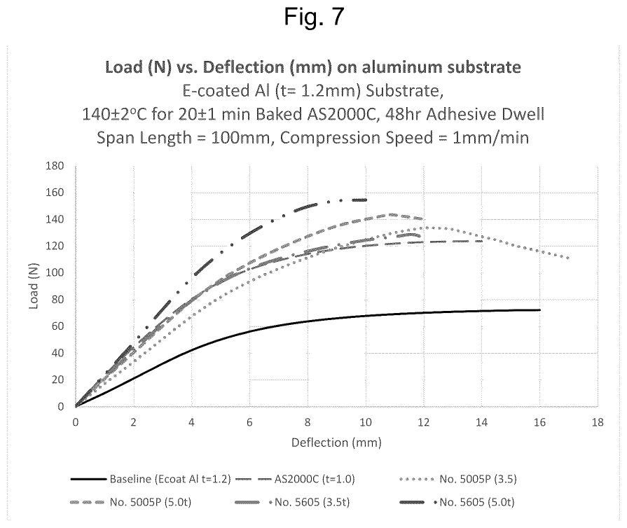

In FIG. 7, the 3-point bend test measurement results demonstrate that laminating an aluminum panel with the material of the present invention using four different materials—adhesive 5005P with 3.5 mm thick stiffening layer, adhesive 5005P with 5 mm thick stiffening layer, adhesive 5605 with 3.5 mm thick stiffening layer, and adhesive 5605 with 5.0 mm thick stiffening layer (all available from Nitto Denko Corporation, Tokyo, Japan)—results in excellent reinforcement obtained, allowing at least 13 mm, 11 mm, about 12 mm, and/or about 10 mm displacement while maintaining a positive slope, exhibiting a non-fracture or stress failure at 135 N, 140 N, 130 N, and 155 N, respectively, compared to merely e-coating the aluminum panel. In this test, the baseline blank was first made by e-coating an aluminum panel of 1.2 mm thickness. Additionally, for comparison purposes, a conventional baked-on stiffening product called AS2000C (Nitto Denko Corporation, Tokyo, Japan) that does not use a honeycombed layer was baked onto an aluminum panel at about 140° C. for about 20 minutes and a 3-point test was performed thereon, showing reinforcement effects allowing 14 mm displacement while maintaining a positive slope, exhibiting a non-fracture or stress failure at about 120 N. The other adhesive samples were adhered with one back and forth stroke using a 2.2 kg roller and allowed to dwell at room temperature for 48 hours.

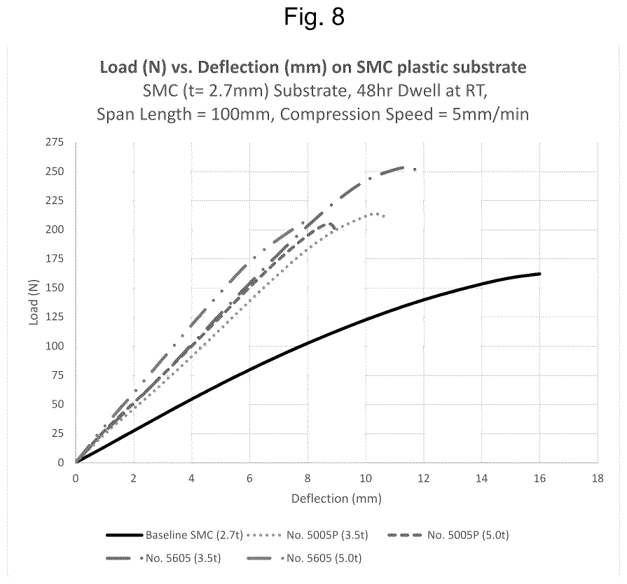

In FIG. 8, the 3-point bend test measurement results demonstrate that laminating an SMC (sheet molding compound) plastic panel with the material of the present invention using adhesive 5005P with 3.5 mm thick stiffening layer, adhesive 5005P with 5.0 mm thick stiffening layer, adhesive 5605 with 3.5 mm thick stiffening layer, and adhesive 5605 with 5.0 mm thick stiffening layer (all available from Nitto Denko Corporation, Tokyo, Japan) results in improved reinforcement obtained, allowing at least 10 mm, 8.5 mm, 11 mm, and/or 8 mm displacement while maintaining a positive slope, exhibiting a non-fracture or stress failure at 210 N, 205 N, 250 N, or 210 N respectively, compared to a baseline SMC measurement. In this test, the baseline blank SMC had a thickness of 2.7 mm. The adhesives were adhered with one back and forth stroke using a 2.2 kg roller and allowed to dwell at room temperature for 48 hours. The span length was 100 mm and the compression speed was 5 mm/min.

Part 2

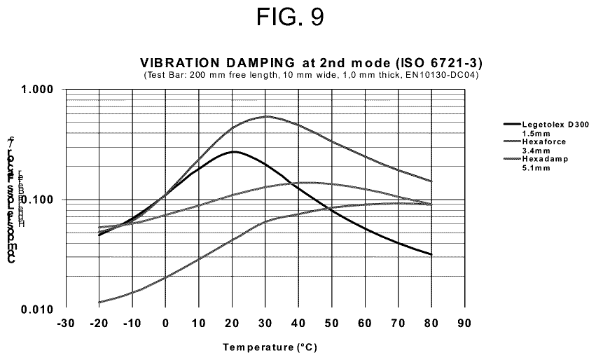

Damping properties were evaluated according to ISO 6721-2 (Oberst test) and test specimens CE-1, CE-2 and Ex-1, were applied to a 10 mm wide and 1 mm thick steel bar with a free length of 200 mm and the loss factor for the 30 second mode of the bar was measured. The conventional product showed satisfactory properties up to standard temperatures (up to about 30° C.). The laminate in accordance with the present invention however shows clearly superior properties in the temperature range of from 40 to 80° C. Taking into account that a similar thickness is given, but with a much reduced density for the laminate in accordance with the present invention, it is clear that the Ex-1 embodiment provides a distinctively different damping than comparative material (see FIG. 9). While several illustrative embodiments of the invention have been shown and described, numerous variations and alternate embodiments will occur to those skilled in the art. Such variations and alternate embodiments are contemplated and can be made without departing from the spirit and scope of the invention as defined in the appended claims.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

It will be understood by those of skill in the art that numerous and various modifications can be made without departing from the spirit of the present invention. Therefore, it should be clearly understood that the forms of the present invention are illustrative only and are not intended to limit the scope of the present invention.

1. A reinforcing element for attaching to a substrate, the element comprising:
a stiffening layer;
a first thermoplastic adhesive layer adhering the stiffening layer to the substrate, the adhesive having a cure temperature below 600° C.;
a high tensile modulus layer; and
a second thermoplastic or thermoset adhesive layer, the high tensile modulus layer adhering to the stiffening layer by the second adhesive layer, and the first and second adhesive layers having a shear strength of at least 500 N/4 cm².

2. The reinforcing element of claim 1, further comprising a release liner layer.

3. The reinforcing element of claim 1, wherein the stiffening layer comprises a honeycombed core element.

4. The reinforcing element of claim 1, wherein the thermoplastic adhesive layer comprises a pressure sensitive adhesive.

5. The reinforcing element of claim 3, wherein the pressure sensitive adhesive comprises acrylate.

6. The reinforcing element of claim 3, wherein the pressure sensitive adhesive comprises polyacrylate.
